(19) United States
(12) Patent Application Publication
(10) Pub. No.: US 2016/0039670 A1
(43) Pub. Date: Feb. 11, 2016

(54) PROCESS AND PLANT FOR PRODUCING SYNTHESIS GAS

(71) Applicant: L'AIR LIQUIDE SOCIÉTÉ ANONYME POUR L'ETUDE ET L'EXPLOITATION DES PROCÉDÉS GEORGES CLAUDE, Paris (FR)

(72) Inventors: Tobias OELMANN, (US); Dierk MULLER, Karben (DE); Veronika GRONEMANN, Karben (DE)

(73) Assignee: L'Air Liquide, Societe Anonyme pour I'Etude et I'Exploitation des Procedes Georges Claude, Paris (FR)

(21) Appl. No.: 14/780,374

(22) PCT Filed: Feb. 11, 2014
(86) PCT No.: PCT/EP2014/052646

§ 371 Date: Sep. 25, 2015

(30) Foreign Application Priority Data
Mar. 28, 2013 (DE) 10 2013 103 187.0

(51) Int. Cl. C01B 3/38

(52) U.S. Cl. CPC C01B 3/382; C01B 2203/0233; C01B 2203/0244; C01B 2203/1058; C01B 2203/1235; C01B 2203/142

(57) ABSTRACT

For producing a synthesis gas containing hydrogen and carbon monoxide from a starting gas containing hydrocarbons, the starting gas is split up into a first partial stream and a second partial stream, wherein the first partial stream is supplied to a steam reformer in which it is catalytically converted together with steam to obtain a gas stream containing hydrogen and carbon oxides, wherein after the steam reformation the first partial stream is again combined with the second partial stream, and wherein the combined gas stream is supplied to an autothermal reformer in which the combined gas stream together with an oxygen-containing gas is autothermally reformed to a synthesis gas. The first partial stream is guided directly into the steam reformer and the second partial stream is guided through a pre-reformer before passing through the autothermal reformer.

### CROSS REFERENCE TO RELATED APPLICATIONS

This application is a §371 of International PCT Application PCT/EP2014/052646, filed Feb. 11, 2014, which claims the benefit of DE 10 2013 103 187.0, filed Mar. 28, 2013, both of which are herein incorporated by reference in their entireties.

### TECHNICAL FIELD OF THE INVENTION

The present invention relates to a process for producing a synthesis gas containing hydrogen and carbon monoxide from a starting gas containing hydrocarbons, wherein a feed stream of the starting gas is split up into a first partial stream and a second partial stream, wherein the first partial stream is supplied to a steam reformer in which it is catalytically converted together with steam to obtain a gas stream containing hydrogen and carbon oxides, wherein after the steam reformation the first partial stream is again combined with the second partial stream to obtain an entire stream, and wherein the entire stream is supplied to an autothermal reformer in which it is autothermally reformed together with gas rich in oxygen to obtain a synthesis gas. The invention furthermore comprises a plant for carrying out the process.

### BACKGROUND

In principle, all hydrogen-containing gas mixtures which can be used as starting substances of a synthesis reaction are referred to as synthesis gas. Typical syntheses for which synthesis gas is used are the methanol and the ammonia synthesis.

In principle, the production of synthesis gas can be effected from solid, liquid and gaseous starting substances. The most important gaseous synthesis gas production, the so-called reformation, utilizes natural gas as educt. Natural gas substantially is a mixture of gaseous hydrocarbons whose composition varies depending on the place of origin, wherein the main component always is methane (CH₄) and as further components higher hydrocarbons with two or more carbon atoms as well as impurities, e.g. sulfur, can be contained.

For reforming natural gas to synthesis gas the so-called steam reformation (also steam reforming) is used above all, in which on a catalyst the contained methane chiefly is converted into hydrogen (H₂), carbon monoxide (CO) and carbon dioxide (CO₂) according to the following reaction equations:

CH₄+3H₂O [symbol] CO+3H₂

CO+H₂O [symbol] CO₂+H₂.

When using a suitable catalyst and adding steam, higher hydrocarbons in addition are split up to methane according to the so-called rich gas reaction:

$${C}_{n} {H}_{m} + ( \frac{2 - m}{2} ) {H}_{2} O ↔ ( n - \frac{2 n - m}{4} ) {CH}_{4} + \frac{2 n - m}{4} {CO}_{2} .$$

The highly exothermal character of the methane conversion with water to carbon monoxide dominates the entire steam reformation. The energy input necessary for this endothermal process is realized via an external heating.

The methane conversion can be increased by increasing the S/C ratio (steam to carbon ratio), i.e. by hyperstoichiometric addition of steam.

In principle, synthesis gas also can be obtained from methane by partial oxidation. The partial oxidation of hydrocarbons is to be understood as incomplete combustion, in which above all hardly evaporable higher hydrocarbons can be converted completely. For the use of methane as educt the following gross reaction equation can be indicated:

CH₄+½O₂→CO+2H₂.

This main reaction of the partial oxidation is exothermal and is determined by the oxygen quantity to be added substoichiometrically.

The so-called autothermal reformation describes a mixed process of steam reformation and partial oxidation. In a suitable operating mode, the exothermal process (partial oxidation) and the endothermal process (steam reformation) are adjusted to each other such that no energy must be supplied to the system from outside.

What is problematic when using an autothermal reformer in particular is the presence of higher-valent hydrocarbons, as the same can undergo a multitude of both endothermal and exothermal reactions and thus, in dependence on the composition of the natural gas used, it can very quickly occur that the reaction no longer is conducted autothermally, but heat is produced or consumed. When the autothermal reaction develops into an endothermal reaction, the reaction space cools down, until the existing energy no longer is sufficient to provide the required activation energies, so that no more reaction takes place. When the reaction instead inadvertently proceeds exothermally, there is provided energy which leads to unwanted combustion processes, which in turn likewise are strongly exothermal, so that the reaction no longer proceeds in a controlled way. Both of this must be avoided at all costs.

For this purpose, a so-called pre-reformer generally is used, which converts at least parts of the gas stream used as educt already before the autothermal reformation. From the prior art, a multitude of possible combinations of pre-reformer, steam reformer, partial oxidation and autothermal reformation are known.

The most simple form of such combined reforming, as it is known for example from Ullmann's Encyclopedia of Industrial Chemistry, 6th edition, 1998, electronic release “7.1 Methanol Production from Natural Gas”, completely omits a pre-reformer. Parts of the inlet stream are passed through a steam reformer, while the remaining residual stream is guided in a bypass around this steam reformer. The steam-reformed and the untreated stream subsequently are combined and subjected to an autothermal reformation.

WO 2008/122391 A describes that the entire educt stream is guided through a pre-reformer and this pre-reformed stream subsequently is divided into three partial streams. These partial streams are supplied to an autothermal reformer, a gas-heated reformer and a steam reformer.

DE 10 2006 023 248 A1 also describes that the entire gas stream must be subjected to a pre-reformation. After the pre-reformation, the pre-reformed gas stream is divided into two partial streams, of which the first partial stream is supplied to a steam reformation and after passing the steam reformation is subjected to an autothermal reformation together with the untreated second partial stream. This has the disadvantage that the entire stream is guided through the pre-reformer and the pre-reformer thus must be dimensioned correspondingly large, which distinctly increases the equipment and operating costs.

From EP 0 233 076 B1 it is known that it is possible to split up the natural gas into two streams. A partial stream first is passed through a correspondingly smaller pre-reformer and subsequently through the steam reformer, in which the natural gas together with steam is catalytically converted to a gas stream containing hydrogen and carbon oxides. After passing through the pre-reformer and the steam reformer, the first partial stream then is supplied to the downstream autothermal reformer. The second partial stream is guided past the steam reformer and supplied directly to the autothermal reformer. However, this involves the disadvantage that that partial stream which is guided directly into the autothermal reformer has not yet undergone any pretreatment. In particular when the natural gas contains a relatively high amount of higher-valent hydrocarbons, particularly more than 5% higher-valent hydrocarbons, quite particularly more than 10% higher-valent hydrocarbons, the problem arises here that this partial stream cannot be heated to temperatures above 450° C. An exceedance of this temperature would lead to carbonizations and hence to clogging of the conduits. The relatively low temperature to which this second partial stream maximally can be heated leads to a decrease of the mixing temperature of the two partial streams and thus to a decrease of the inlet temperature into the autothermal reformer. A lower operating temperature in the autothermal reformer, however, in turn leads to the fact that an increased quantity of carbon dioxide is produced and the amount of carbon monoxide decreases.

In addition, a lower inlet temperature into the autothermal reformer involves the risk that the so-called metal dusting occurs. Metal dusting is a form of corrosion, in which a graphite layer is deposited on the surface of the metal, whereby metal carbon tips are formed, which leads to a degradation of the metal body. This graphite layer is formed of carbon which occurs due to a shift of the Boudouard equilibrium.

According to Boudouard, the reaction

CO₂+C→2CO

is an equilibrium reaction which largely depends on the temperature and the partial pressures of CO and CO₂. Due to the endothermal reaction, high temperatures shift the equilibrium to the product side (CO), and an increase in pressure shifts the equilibrium to the side of the educts. When the temperature falls below the Boudouard temperature, the reaction proceeds in the direction CO₂+C. The resulting elementary carbon leads to metal dusting and thus to a considerable damage of the equipment. To avoid this, the temperature of the process gas must lie above the Boudouard temperature (under the process conditions about 670° C.), which by setting the temperature of the second partial stream to a maximum of 450° C. only can be effected when the fraction of the second partial stream is kept correspondingly low, in particular below 50%. However, this distinctly limits the flexibility of the process with regard to splitting up the two partial streams, since the composition of the resulting synthesis gas no longer is freely adjustable by the fractions of the respective partial streams.

Therefore, it is the object of the present invention to provide for the production of synthesis gas with freely selectable hydrogen-to-carbon ratio, in which it is also possible to use natural gas with a high content of hydrocarbons with a chain length of >=2 carbon atoms for the synthesis of a gas rich in carbon monoxide, and the apparatus and operational expenditure is minimized at the same time.

According to the invention, this object is solved by a process with the features of the claims described herein.

In one embodiment of the invention, a feed stream of the starting gas is split up into a first partial stream and a second partial stream. The first partial stream is supplied directly to a steam reformer, in which it is catalytically converted together with steam to obtain a gas stream containing hydrogen and carbon oxides. After passing the steam reformation, the first partial stream is combined with the second partial stream and this entire gas stream is passed into an autothermal reformer, where it is reformed together with gas rich in oxygen to obtain a synthesis gas. Before the autothermal reformation, the second partial stream is supplied to a pre-reformer, while the first partial stream only passes the steam reformer and no pre-reformer. By acting against the opinion held so far in the prior art that the steam reformer definitely requires a pre-reformer, the pre-reformer can be saved for the steam reformer, whereby the additional apparatus and operational expenditure of the process is reduced distinctly. At the same time, the process nevertheless can also be operated with natural gas which contains a distinct fraction of higher-valent hydrocarbons, since before entry into the autothermal reformer the second partial stream is subjected to the pre-reformation and higher-valent hydrocarbons thus are largely removed, which actually provides for heating to temperatures above 450° C. without the risk of carbonizations.

Beside the distinctly smaller pre-reformer and the resulting economic savings, a process in accordance with an embodiment of the invention also has the advantage that it provides for an increased flexibility with respect to the partial streams to be set, and the first partial stream thus can take any value between >0 and <100 vol-% of the entire stream, and the second partial stream correspondingly is calculated as difference between entire stream and partial stream.

It is particularly favorable when in the pre-reformer those reactions exclusively take place which convert higher-valent hydrocarbons with two or more C atoms in their chains to carbon dioxide and methane according to the rich gas reaction. A conversion of the methane to synthesis gas should however be avoided. Preferably 90 wt-%, particularly preferably 95 wt-% and quite particularly preferably 99 wt-% of the higher-valent hydrocarbons are converted to methane and carbon dioxide. The conversion of methane in the pre-reformer accordingly should be <5 wt-%, preferably <1 wt-%. In the circuitry according to the invention, the amounts of hydrogen and carbon monoxide obtained thereby are influenced only by the steam reformer and the autothermal reformer.

It is furthermore advantageous that with this process the composition of the synthesis gas obtained practically can be varied as desired due to the increased flexibility. For the methanol synthesis, for example, a stoichiometric number (SZ) of 2.0 to 2.1 is required, the stoichiometric number for the methanol synthesis being defined by to the following formula:

$$SZ = \frac{{H}_{2} - {CO}_{2}}{CO + {CO}_{2}} .$$

In principle, the steam reformer increases the stoichiometric number, since more hydrogen is produced; whereas the autothermal reformer decreases the stoichiometric number, since less hydrogen and a higher fraction of carbon oxides is obtained.

In that no pre-reformer is provided upstream of the steam reformer, the reaction taking place can distinctly be improved with regard to the stoichiometric number, so that the following applies for the steam reformer:

CH₄+H₂O→CO+3H₂

which in simple terms results in a stoichiometric number of 3. For the autothermal reformer, the stoichiometric number approximately is 1, since in simple terms the following reaction equation can be assumed:

CH₄+O₂→CO+H₂O+H₂.

In the pre-reformer, the higher-valent hydrocarbons are converted into methane. In the steam reformer, on the other hand, a conversion directly to synthesis gas is effected with higher-valent hydrocarbons. Depending on the ratio of stoichiometric numbers SZ to be achieved, the two partial streams thus can be defined independent of the higher-valent natural gas contained in them.

What is also favorable in such circuitry is the possibility opening up for the start-up of the plant, which becomes difficult in that typically the catalysts used in the steam and pre-reformer are active only in reduced form, but—in particular when they are nickel-based—are available on the market only in oxidized form. In the present procedure, the catalyst of the steam reformer first can be reduced, and subsequently the steam reformer can be put into operation. The feed stream of the starting gas is completely guided over the steam reformer, while the bypass stream amounts to 0 vol-%. The gas withdrawn from the steam reformer is supplied to a PSA plant (Pressure Swing Adsorption), in which the hydrogen obtained in the steam reformer is purified by pressure swing adsorption. The hydrogen thus obtained then is supplied to the pre-reformer for the reduction of its catalyst. After the reduction, the two partial streams then can assume values between 0 and 100 vol-%, and the autothermal reformation can be switched in.

To reliably avoid metal dusting in the second partial stream after the exit from the pre-reformer, it was found to be advantageous when the temperature after the pre-reformer lies between 650 and 800° C.

To reliably avoid metal dusting in the combined entire gas stream, the temperature of the entire gas stream should lie above 630° C., preferably between 660 and 800° C.

Furthermore, it was found to be advantageous to heat the first partial stream before entry into the steam reformer to a temperature between 500 and 600° C. and/or the second partial stream before entry into the pre-reformer to a temperature between 400 and 500° C. This ensures optimum operating conditions, whereby high conversions are obtained in the steam reformer, whereas in the pre-reformer exclusively the hydrocarbons with two or more carbon atoms are converted.

In addition, the catalysts for the pre-reformer and the steam reformer likewise are to be defined such that in the steam reformer high conversions equally are achieved for methane and for higher-valent hydrocarbons, whereas in the pre-reformer exclusively carbon compounds with two or more carbon atoms are to be converted to hydrogen, carbon monoxide, carbon dioxide and methane. Therefore, it is recommendable to use a catalyst in the pre-reformer with a nickel content between 20 and 50 wt-%, preferably between 30 and 40 wt-%, whereas the catalyst in the steam reformer has a nickel content between 5 and 10 wt-%, preferably 7.5 to 8.5 wt-%. Preferably, for at least one of the catalysts Al₂O₃ is used as carrier.

During the procedure of the reforming reaction according to the invention the reaction temperature in the pre-reformer lies between 400 and 500° C., whereas the reaction temperature in the steam reformer lies between 600 and 800° C.

It is also favorable to adiabatically operate the pre-reformer, i.e. that here the system is transferred from one state into another, without thermal energy being exchanged with the surroundings. In the adiabatic reaction control the reaction temperature rises linearly with the conversion, so that the gas exiting from the pre-reformer already has a temperature at which metal dusting reliably is avoided. Preferably, the exit temperature from the pre-reformer lies between 650 and 800° C. Then, no further heating is necessary any more.

Embodiments of the invention may furthermore include a plant for the production of a synthesis gas containing hydrogen and carbon monoxide with the features described herein, which is suitable for carrying out the process mentioned above. Such plant comprises a splitter which splits up the starting gas into a first partial stream and a second partial stream. Furthermore, the plant comprises a steam reformer in which the first partial stream is catalytically converted with steam to obtain a gas stream containing hydrogen and carbon oxides, and an autothermal reformer in which the first partial stream guided over the steam reformer as well as the second partial stream are autothermally reformed together with gas rich in oxygen. It is decisive that the first partial stream is guided via a conduit from the splitter directly into the steam reformer and the second partial stream is guided via a pre-reformer into the autothermal reformer. This results in the fact that the partial stream of the steam reformation no longer must be subjected to a pre-reformation, whereby the apparatus and operational expenditure can be reduced distinctly.

The pre-reformer preferably is operated adiabatically with an upstream preheating. The steam reformer is fired from outside.

It is advantageous to provide a heat exchanger both in the conduit which guides the first partial stream from the splitter into the steam reformer and in the conduit which guides the second partial stream into the pre-reformer, so that the inlet temperature of the two streams can be adjusted individually for the respective process to be carried out.

Further developments, advantages and possible applications of the invention can also be taken from the following description of an exemplary embodiment and the drawing. All features described and/or illustrated form the subject-matter of the invention per se or in any combination, independent of their inclusion in the claims or their back-references.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments

The FIGURE schematically shows a process according to an embodiment of the invention for the production of synthesis gas.

### DETAILED DESCRIPTION

The Figure schematically illustrates the procedure of the process according to the invention for the production of synthesis gas in a process flow diagram. Natural gas is introduced into a condenser 2 via conduit 1 and then via conduit 3 into a hydrogenation 4. There, the natural gas is treated with hydrogen on a suitable catalyst, e.g. a nickel catalyst, so that saturated hydrocarbon compounds are obtained.

Via conduit 5, the gas thus obtained is supplied to a desulfurization 6, from which the entire stream gets into a splitter 8 via conduit 7.

In the splitter 8, the entire stream is split up into the partial streams T1 and T2. The first partial stream T1 is supplied to the steam reformer 13 via conduit 10, wherein steam initially is admixed to the partial stream T1 via conduit 11 and in the heat exchanger 12 the resulting mixed stream then is brought to the required inlet temperature for the steam reformer 13. In the reactor 13, steam reforming of the pretreated natural gas is performed. Via conduit 14, the steam-reformed gas subsequently is transferred into a mixing zone 30.

The second partial stream T2 is guided from the splitter 8 via conduit 20 into a pre-reformer 23. For carrying out the pre-reformation, steam is admixed to the partial stream T2 via conduit 21 and the resulting second mixed stream is heated to the required inlet temperature in the heat exchanger 22. The exit stream of the pre-reformer 23 likewise is transferred into the mixer 30 via conduit 24, wherein the stream is heated even further in the heat exchanger 25 downstream of the pre-reformer 23, so that the two streams T1 and T2 are supplied to the mixing system 30 preferably with a similar temperature, particularly preferably with a temperature difference of <=20° C., so that no mixing problems occur.

From the mixing zone 30 the resulting new entire stream is fed into the autothermal reformer 32 via conduit 31. For operating the autothermal reformer 32, air is introduced into an air separation 34 via conduit 33, and the oxygen obtained there is fed into the autothermal reformer 32 via conduit 35, the condenser 36 and conduit 37. Via conduit 40, the product gas obtained in the reactor 32 is withdrawn. Additional water and/or CO₂ likewise can be introduced into the reformer 32.

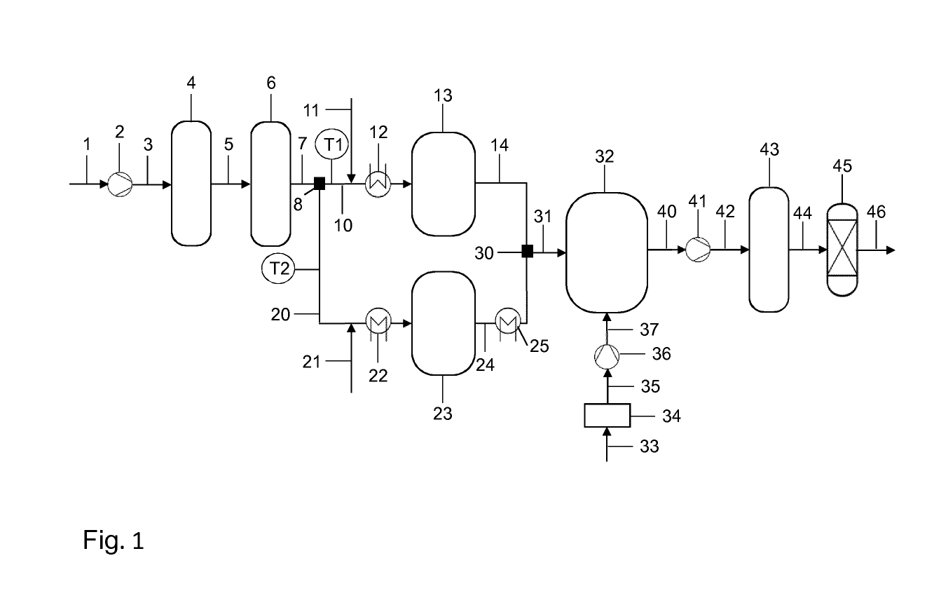

By way of example, FIG. 2 shows that the product gas from conduit 40 can be supplied to a methanol synthesis 43 via a condenser 41 and conduit 42, and then via conduit 44 to a methanol distillation 45, from which methanol finally can be withdrawn via conduit 46. Of course, a number of other syntheses, e.g. the ammonia synthesis or the Fischer-Tropsch process equally can be provided downstream of the reforming process.

As in the circuitry according to the invention a certain ratio of stoichiometric numbers easily can be adjusted independent of the composition of the natural gas, it is also possible to offer a plurality of synthesis processes subsequent to the reformation, for which the ratio of stoichiometric numbers each can be adjusted individually.

### Example

The following example shows the composition of the individual streams and the associated process parameters.

| | Process stream | | | | | | | |
|---|---|---|---|---|---|---|---|---|
| | | | Partial | | Partial | | Partial | |
| | | | stream T1 | | stream T1 | | stream T2 | |
| | | | before steam | | after steam | | before pre- | |
| | Starting gas | | reformer | | reformer | | reformer | |
| | Phase | | | | | | | |
| | gaseous | | gaseous | | gaseous | | gaseous | |
| Composition | kmol/h | mol-% | kmol/h | mol-% | kmol/h | mol-% | kmol/h | mol-% |
| CO₂ | 18.7 | 0.43 | 9.4 | 0.11 | 620.8 | 6.01 | 9.4 | 0.21 |
| CO | 5.3 | 0.12 | 2.6 | 0.03 | 412.3 | 3.99 | 2.6 | 0.06 |
| H₂ | 129.9 | 3.00 | 64.9 | 0.78 | 3632.7 | 35.1 | 64.9 | 1.49 |
| CH₃OH | 0.9 | 0.02 | 0.4 | 0.01 | | 4 | 0.4 | 0.01 |
| H₂O | 0.1 | 0.00 | 6130.7 | 73.9 | 4498.6 | | 2189.5 | 50.29 |
| O₂ | | | | 1 | | 43.5 | | |
| N₂ | 6.8 | 0.16 | 3.4 | | 3.4 | 2 | 3.4 | 0.08 |
| Aromatics | 1.6 | 0.04 | 0.8 | 0.04 | 0.8 | | 0.8 | 0.02 |
| CH₄ | 4 | 92.7 | 2007.3 | 0.01 | 1168.4 | 0.03 | 2007.3 | 46.11 |
| C₂H₆ | 4014. | 5 | 55.6 | 24.2 | | 0.01 | 55.6 | 1.28 |
| C₃H₈ | 6 | 2.57 | 11.8 | 0 | | 11.3 | 11.8 | 0.27 |
| C₄H₁₀ | 111.2 | 0.55 | 5.0 | 0.67 | | 0 | 5.0 | 0.11 |
| C₅H₁₂ | 23.7 | 0.23 | 2.3 | 0.14 | | | 2.3 | 0.06 |
| C₆H₁₄ | 10.0 | 0.11 | 0.6 | 0.06 | | | 0.6 | 0.01 |
| C₇H₁₆ | 4.6 | 0.03 | | 0.03 | | | | |
| | 1.2 | | | 0.01 | | | | |

| | | | | |
|---|---|---|---|---|
| Total molar flow | 4328.5 | 8294.9 | 10337.1 | 4353.7 |
| rate (kmol/h) | | | | |
| Total mass flow | 71236 | 146108 | 146108 | 75107 |
| rate [kg/h] | | | | |
| Current volumetric | 4982 | 13377 | 23225 | 6533 |
| flow rate (m³/h) | | | | |
| Temperature (° C.) | 375 | 560 | 760 | 480 |
| Pressure (bar | 47.50 | 42.50 | 38.50 | 41.50 |
| (abs)) | | | | |
| Density (kg/m³) | 14.32 | 10.92 | 6.29 | 11.50 |
| Mol. weight | 16.48 | 17.61 | 14.13 | 17.25 |

| | Process stream | | | | | |
|---|---|---|---|---|---|---|
| | Partial stream T2 | | Partial stream T2 | | | |
| | before pre- | | after pre- | | combined gas | |
| | reformer | | reformer | | stream | |
| | Phase | | | | | |
| | gaseous | | gaseous | | V gaseous | |
| Composition | kmol/h | mol-% | kmol/h | mol-% | kmol/h | mol-% |
| CO₂ | 89.2 | 1.98 | 89.2 | 1.98 | 710.0 | 4.78 |
| CO | 1.6 | 0.04 | 1.6 | 0.04 | 414.0 | 2.79 |
| H₂ | 274.5 | 6.09 | 274.5 | 6.09 | 3907.2 | 26.31 |
| CH₃OH | | | | | | |
| H₂O | 2031.2 | 45.02 | 2031.2 | 45.02 | 6529.8 | 43.98 |
| O₂ | | | | | | |
| N₂ | 3.4 | 0.028 | 3.4 | 0.08 | 6.8 | 0.05 |
| Aromatics | 0.8 | 0.02 | 0.8 | 0.02 | 1.6 | 0.01 |
| CH₄ | 2110.7 | 46.78 | 2110.7 | 3279.1 | 3279.1 | 22.08 |
| C₂H₆ | | | | | | |
| C₃H₈ | | | | | | |
| C₄H₁₀ | | | | | | |
| C₅H₁₂ | | | | | | |
| C₆H₁₄ | | | | | | |
| C₇H₁₆ | | | | | | |

| | | | |
|---|---|---|---|
| Total molar flow rate | 4511.5 | 4511.5 | 14848.5 |
| (kmol/h) | | | |
| Total mass flow rate [kg/h] | 75107 | 75107 | 221216 |
| Current volumetric flow rate | 6635 | 9034 | 31682 |
| (m³/h) | | | |
| Temperature (° C.) | 446 | 650 | 708 |
| Pressure (bar (abs)) | 40.50 | 38.50 | 38.50 |
| Density (kg/m³) | 11.32 | 8.31 | 6.98 |
| Mol. weight | 16.65 | 16.65 | 14.90 |

Standard steam flow (Nm³/h) based on 0° C. and 101.25 Pa.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

### LIST OF REFERENCE NUMERALS

1 conduit
2 compressor
3 conduit
4 hydrogenation
5 conduit
6 desulfurization
7 conduit
8 splitter
10, 11 conduit
13 steam reformer
14 conduit
20, 21 conduit
22 heat exchanger
23 pre-reformer
24 conduit
25 heat exchanger
30 mixing zone
31 conduit
32 autothermal reformer
33 conduit
34 air separation
35 conduit
36 compressor
37 conduit
40 conduit
41 condenser
42 conduit
43 methanol synthesis
44 conduit
45 methanol distillation
46 conduit
T1 first partial stream
T2 second partial stream

1-12. (canceled)

13. A process for producing a synthesis gas containing hydrogen and carbon monoxide from a starting gas containing hydrocarbons, the process comprising the steps of:
splitting the starting gas into a first partial stream and a second partial stream;
supplying the first partial stream to a steam reformer in the presence of steam under conditions effective to catalytically convert the first partial stream with the steam to obtain a gas stream containing hydrogen and carbon oxides;
following steam reformation, combining the first partial stream with the second partial stream to form a combined gas stream; and
supplying the combined gas stream to an autothermal reformer under conditions effective for autothermally reforming the combined gas stream together with an oxygen-containing gas to a synthesis gas,
wherein the first partial stream is guided directly into the steam reformer and the second partial stream is guided through a pre-reformer before passing through the autothermal reformer.

14. The process according to claim 13, wherein the hydrocarbons with two or more carbon atoms, which are contained in the partial stream, are converted to at least 90 wt-% of carbon dioxide and methane in the pre-reformer.

15. The process according to claim 13, wherein the temperature of the combined gas stream lies between 660 and 800° C.

16. The process according to claim 13, wherein the partial stream is supplied to the steam reformer with a temperature between 500 and 600° C. and/or the partial stream is supplied to the pre-reformer with a temperature between 400 and 500° C.

17. The process according to claim 13, wherein a catalyst for the pre-reformer has a nickel content between 2 and 20 wt-%.

18. The process according to claim 13, wherein a catalyst for the steam reformer has a nickel content between 30 and 40 wt-%.

19. The process according to claim 13, wherein the reaction temperature in the pre-reformer lies between 400 and 500° C.

20. The process according to claim 13, wherein the reaction temperature in the steam reformer lies between 600 and 800° C.

21. The process according to claim 13, wherein the pre-reformer is operated adiabatically.

22. The process according to claim 13, wherein the starting gas exits from the pre-reformer with a temperature between 650 and 800° C.

23. A plant for the production of a synthesis gas containing hydrogen and carbon monoxide from a starting gas containing hydrocarbons, the plant comprising:
a splitter configured to split up the starting gas into a first partial stream and a second partial stream;
a steam reformer configured to catalytically convert the first partial stream with steam to obtain a gas stream containing hydrogen and carbon oxides; and
an autothermal reformer in which the first partial stream and the second partial stream are autothermally reformed together with gas containing oxygen,
wherein the splitter and the steam reformer are in fluid communication with each other such that the steam reformer is configured to receive the first partial stream from the splitter; and
a pre-reformer disposed between the splitter and the autothermal reformer and in fluid communication with the splitter and the autothermal reformer, such that the pre-reformer is configured to receive the second partial stream from the splitter.

24. The plant according to claim 23, further comprising a first heat exchanger disposed downstream the splitter and upstream the steam reformer.

25. The plant according to claim 23, further comprising a second heat exchanger disposed downstream the splitter and upstream the pre-reformer.

26. The plant according to claim 23, wherein the steam reformer and the pre-reformer are arranged in parallel with each other.
